(19) United States
(12) Patent Application Publication
(10) Pub. No.: US 2009/0304128 A1
(43) Pub. Date: Dec. 10, 2009

(54) Packet Detection Apparatus and Method, Wireless Communication Apparatus and Method, and Computer Program

(76) Inventors: Seiichi IZUMI, Kanagawa (JP); Osamu Ito, Tokyo (JP)

Correspondence Address: FINNEGAN, HENDERSON, FARABOW;GARRETT & DUNNER, L.L.P., 901 New York Avenue, NW, Washington, DC, 20001-4413, US

(21) Appl. No.: 12/535,405

(22) Filed: Aug. 4, 2009

(30) Foreign Application Priority Data
Jun. 8, 2008 (JP) P2008-202719

(51) Int. Cl. H04L 27/06

(52) U.S. Cl. 375/343

(57) ABSTRACT

A packet detection apparatus detects a packet from a received signal by using a preamble containing an established, repeating training sequence. A first autocorrelation calculator computes a first autocorrelation of the received signal over a first interval. A first determining unit determines packet discovery by comparing the first autocorrelation to a first autocorrelation threshold value. A second autocorrelation calculator computes a second autocorrelation of the received signal over a second interval equivalent to the interval length for packet discovery announcement. A second determining unit determines packet discovery announcement by comparing the second autocorrelation to a second autocorrelation threshold value lower than the first autocorrelation threshold value.

### BACKGROUND OF THE INVENTION

1. Field of the Invention

The present invention relates to a packet detection apparatus and method, a wireless communication apparatus and method, and a computer program, whereby the preamble of a packet arriving from a communication partner is used for synchronization and packet reception. More particularly, the present invention relates to a packet detection apparatus and method, a wireless communication apparatus and method, and a computer program whereby packet discovery is conducted by autocorrelation of an established training sequence repeatedly contained in the preamble.

In further detail, the present invention relates to a packet detection apparatus and method, a wireless communication apparatus and method, and a computer program wherein clear channel assessment and AGC gain locking is conducted in accordance with packet discovery. More particularly, the present invention relates to a packet detection apparatus and method, a wireless communication apparatus and method, and a computer program whereby clear channel assessment and AGC gain locking is conducted in a short amount of time from the beginning of the packet.

2. Description of the Related Art

Wireless networks are now the subject of much attention, being systems free from the wiring involved in wired communication methods of the past. Specifications such as IEEE 802.11 (Institute of Electrical and Electronics Engineers 802.11) and IEEE 802.15 are recognized standards for wireless networks. For example, in IEEE 802.11a/g, a type of multi-carrier modulation method known as orthogonal frequency division multiplexing (OFDM) is implemented as a standard wireless LAN specification.

In addition, although the IEEE 802.11a/g standard supports modulation methods that can achieve a maximum data transfer rate of 54 Mbps, there is demand for a next-generation wireless LAN standard able to realize even greater bit rates. Consequently, a MIMO-OFDM communication method that uses multiple antennas to conduct transmit beamforming in accordance with channel characteristics has been adopted in IEEE 802.11n, an amendment to the IEEE 802.11 standard.

In wireless communication, a preamble made up of an established, repeating sequence is typically added to the packet header. At the receiver, the preamble is used for synchronization. More specifically, when a packet is discovered by preamble detection, accurate receive timing confirmation and frequency offset correction is subsequently performed. In addition, normalization of the received signal power is also conducted where appropriate. Subsequently, the valid symbol portions of the OFDM symbols are extracted, and the received signal is then fed to a fast Fourier transform (FFT).

Herein, packet discovery normally involves autocorrelation of an established training sequence repeatedly contained in the preamble, wherein a packet is discovered as a result of the autocorrelation value exceeding a threshold value. The autocorrelation can be calculated by taking the running total or moving average of the complex conjugate multiplication results for a received signal and a delay signal received earlier by one repeating period.

The normalization of the received signal power is conducted by automatic gain control (AGC) amplification. More specifically, the receiver first stands by to receive with a large AGC gain applied. When a change occurs in the received signal power, the received power is roughly normalized by AGC amplification, thereby narrowing the dynamic range of the received signal power. Subsequently, signal amplitude (i.e., AGC gain) adjustment is conducted so as to obtain suitable receive levels fitting within the dynamic range of the AD converter.

For example, a demodulation timing generator circuit has been proposed wherein, after conducting AGC control and frequency offset correction with a burst training sequence used for synchronization that is included in the packet header, a detection window for autocorrelation detection is set, autocorrelation peak detection is conducted, and an optimal FFT window independent of transmission path conditions is then set (see Japanese Unexamined Patent Application Publication No. 2003-69546, for example).

FIG. 13 illustrates the preamble structure stipulated in IEEE 802.11a/g. As shown in FIG. 13, the beginning of the packet contains an 8.0 microsecond short preamble interval (the short training field, or STF) and an 8.0 microsecond long preamble interval (the long training field, or LTF). In the short preamble interval, short preambles t₁ to t₁₀ made up of a short training sequence (STS) are sent in a burst. In other words, the short preamble is repeated 10 times. In the long preamble interval, a 1.6 microsecond guard interval GI2 is followed by long preambles T₁ to T₂ made up of a long training sequence (LTS). In other words, the long preamble is repeated twice. In a typical receiver, four 0.8 microsecond STS symbols are used to conduct AGC gain configuration and DC offset correction. Subsequently, the remaining six STS symbols are used to conduct frequency offset estimation and compensation, packet detection, and rough timing detection.

In a wireless LAN configured according to IEEE 802.11a/n, for example, it is desirable for the receiver to output a clear channel assessment (CCA) signal from the physical layer to the media access control (MAC) layer within the first 4 microseconds elapsing from the beginning of the packet. CCA is a mechanism for preventing signal cross-talk and receive errors by temporally multiplexing a plurality of wireless stations on a single carrier. For example, in the CCA specified by IEEE 802.11a, a transmit station monitors the carrier before transmitting, and aborts transmission if the received power of the detected signal is −82 dBm or greater. On the receiver side, the AGC gain is first adjusted and locked, and then the DC offset is also corrected, all within the short amount of time given by the STF interval.

When the discovery of a packet during synchronization processing triggers the output of a CCA signal from the physical layer to the MAC layer or the locking of the AGC gain (see Japanese Unexamined Patent Application Publication No. 2004-221940, FIGS. 19 and 20, for example), the signal detection sensitivity is raised in order to conduct packet discovery in a short amount of time.

However, if the autocorrelation threshold value is lowered in order to raise the sensitivity of packet discovery, the receiver becomes more sensitive to noise and other factors, and packets that could otherwise be safely ignored might be discovered. Since the MAC layer suppresses transmission when a CCA signal is output, there is concern that if the receiver is overly sensitive to noise and non-IEEE 802.11a/n signals, then the throughput might become limited due to over-suppression of transmit operations. Since the communication apparatus acting as the recipient of the data frame also transmits an ACK, excessive packet discovery similarly limits throughput.

In addition, if it is attempted to lock the AGC gain in accordance with excessive packet discovery, receive operations are reset following the subsequent packet error detection, and thus the AGC gain is frequently locked and unlocked. As a result, the ability to smoothly conduct gain control within a predetermined amount of time upon packet arrival might be lost.

If the opposite of the above is conducted and the autocorrelation value is increased, then the sensitivity of packet discovery announcement is lowered, and the packet discovery timing is delayed. For this reason, the receiver might not be able to satisfy the stipulation that the CCA be issued from the physical layer to the MAC layer within the 4 microseconds at the beginning of the packet. Furthermore, the timing of the AGC gain locking is also delayed as a result of the delayed packet discovery announcement. As a result, subsequent frequency offset and channel estimations are affected, and decoding errors may occur.

In order to conduct packet discovery, the autocorrelation of the received signal is computed in the STF interval. During this time, a peak is created by computing the moving average over an interval equivalent to the entire STF interval, and the timing of the peak is derived. However, if a packet is discovered at around 4 microseconds (equivalent to half the STF interval length), then the signal for the packet interval enters halfway through the moving average interval. Packet discovery is thus determined with noise interval signals in the remaining half of the interval, leaving the receiver susceptible to noise.

### SUMMARY OF THE INVENTION

It is thus desirable to provide a packet detection apparatus and method, a wireless communication apparatus and method, and a computer program whereby packet discovery is suitably conducted by autocorrelation of an established training sequence repeatedly contained in the preamble.

It is furthermore desirable to provide a packet detection apparatus and method, a wireless communication apparatus and method, and a computer program whereby clear channel assessment and AGC gain locking are suitably conducted in accordance with packet discovery.

It is furthermore desirable to provide a packet detection apparatus and method, a wireless communication apparatus and method, and a computer program whereby clear channel assessment and AGC gain locking are suitably conducted in a short amount of time from the beginning of the packet.

A packet detection apparatus in accordance with an embodiment of the present invention detects a packet from a received signal by using a preamble made up of an established, repeating training sequence added to the beginning of the packet. The packet detection apparatus includes: a first autocorrelation calculator configured to solve for a first autocorrelation of the received signal over a first interval; a first determining unit configured to make a packet discovery determination on the basis of the result of comparing the first autocorrelation computed by the first autocorrelation calculator to a first autocorrelation threshold value; a second autocorrelation calculator configured to solve for a second autocorrelation of the received signal over a second interval equivalent to the interval length for packet discovery announcement; and a second determining unit configured to make a packet discovery announcement determination on the basis of the result of comparing the second autocorrelation computed by the second autocorrelation calculator to a second autocorrelation threshold value lower than the first autocorrelation threshold value.

Herein, the first interval may be equivalent to the preamble interval length, and the second interval may be shorter than the first interval. Consequently, the first autocorrelation calculator takes the autocorrelation of an established training sequence over the entire interval length of the preamble, and the first determining unit is then able to discover a packet from the autocorrelation over the entire interval length of the preamble.

In addition, the first and the second autocorrelation calculators may respectively compute moving averages of the complex conjugate multiplication results for the received signal and a delay signal received earlier by one repeating period of the training sequence in the first and second intervals, and thereby respectively compute the first and second autocorrelations.

In addition, in the packet detection apparatus in accordance with an embodiment of the present invention, the first determining unit may be configured to additionally make a packet discovery announcement if the second determining unit has not yet made a packet discovery announcement at the time of the first determining unit determining packet discovery.

A packet detection apparatus in accordance with another embodiment of the present invention detects a packet from a received signal by using a preamble made up of an established, repeating training sequence added to the beginning of the packet. The packet detection apparatus includes: an autocorrelation calculator configured to solve for the autocorrelation of the received signal for each repeating period of the established training sequence; a normalizer configured to normalize the autocorrelation computed by the autocorrelation calculator to the average received signal power in a given interval; a plurality of serially-connected delay units each configured to apply delay equal to one repeating period of the established training sequence, wherein the number of delay units corresponds to the number of times the established training sequence is repeated; a first summing unit configured to calculate the sum of the normalized autocorrelations respectively output from the normalizer and all of the serially-connected delay units; a first determining unit configured to make a packet discovery determination on the basis of the result of comparing the first normalized autocorrelation sum output by the first summing unit to a first autocorrelation threshold value; a second summing unit configured to calculate the sum of the normalized autocorrelations respectively output from the normalizer and a predetermined number of serially-connected delay units starting from the first; and a second determining unit configured to make a packet discovery announcement determination on the basis of the result of comparing the second normalized autocorrelation sum output by the second summing unit to a second autocorrelation threshold value lower than the first autocorrelation threshold value.

Herein, the total delay time calculated by the second summing unit and found in the output of the last delay unit may be equivalent to the interval length for the packet discovery announcement. The second determining unit then makes a packet discovery announcement from the normalized autocorrelation in a moving average interval equivalent to the interval length for packet discovery announcement.

In addition, in the packet detection apparatus in accordance with the above embodiment of the present invention, the first determining unit may be configured to additionally make a packet discovery announcement if the second determining unit has not yet made a packet discovery announcement at the time of the first determining unit determining packet discovery.

A packet detection method in accordance with an embodiment of the present invention detects a packet from a received signal by using a preamble made up of an established, repeating training sequence added to the beginning of the packet. The method includes the steps of: calculating a first autocorrelation of the received signal over a first interval; making a packet discovery determination on the basis of the result of comparing the first autocorrelation computed in the first autocorrelation calculating step to a first autocorrelation threshold value; calculating a second autocorrelation of the received signal over a second interval equivalent to the interval length for packet discovery announcement; and making a packet discovery announcement determination on the basis of the result of comparing the second autocorrelation computed in the second autocorrelation calculating step to a second autocorrelation threshold value lower than the first autocorrelation threshold value.

In addition, a packet detection method in accordance with another embodiment of the present invention detects a packet from a received signal by using a preamble made up of an established, repeating training sequence added to the beginning of the packet. The method includes the steps of: calculating the autocorrelation of the received signal for each repeating period of the established training sequence; normalizing the autocorrelation computed in the autocorrelation calculating step to the average received signal power in a given interval; calculating a first sum of the normalized autocorrelation obtained in the normalizing step and a number of delay signals wherein the normalized autocorrelation is successively delayed by one repeating period of the established training sequence, and wherein the number of delay signals is equal to the number of times the established training sequence is repeated; making a packet discovery determination on the basis of the result of comparing the first normalized autocorrelation sum output in the first summing step to a first autocorrelation threshold value; calculating a second sum of the normalized autocorrelation obtained in the normalizing step and a number of delay signals wherein the normalized autocorrelation is successively delayed by one repeating period of the established training sequence, up to a delay time corresponding to the interval length for packet discovery announcement; and making a packet discovery announcement determination on the basis of the result of comparing the second normalized autocorrelation sum output in the second summing step to a second autocorrelation threshold value lower than the first autocorrelation threshold value.

A wireless communication apparatus in accordance with another embodiment of the present invention includes: a receiver configured to receive a packet wherein a preamble made up of an established, repeating training sequence has been added to the beginning thereof; a first autocorrelation calculator configured to solve for a first autocorrelation of a received signal over a first interval; a first determining unit configured to make a packet discovery determination on the basis of the result of comparing the first autocorrelation calculated by the first autocorrelation calculator to a first autocorrelation threshold value; a second autocorrelation calculator configured to solve for a second autocorrelation of the received signal over a second interval equivalent to the interval length for packet discovery announcement; a second determining unit configured to make a packet discovery announcement determination on the basis of the result of comparing the second autocorrelation computed by the second autocorrelation calculator to a second autocorrelation threshold value lower than the first autocorrelation threshold value; and a packet discovery announcement processor configured to conduct predetermined processing in accordance with the packet discovery announcement determination made by the second determining unit.

A wireless communication apparatus in accordance with another embodiment of the present invention includes: a receiver configured to receive a packet wherein a preamble made up of an established, repeating training sequence has been added to the beginning thereof; an autocorrelation calculator configured to solve for the autocorrelation of a received signal for each repeating period of the established training sequence; a normalizer configured to normalize the autocorrelation computed by the autocorrelation calculator to the average received signal power in a given interval; a plurality of serially-connected delay units each configured to apply delay equal to one repeating period of the established training sequence, wherein the number of delay units corresponds to the number of times the established training sequence is repeated; a first summing unit configured to calculate the sum of the normalized autocorrelations respectively output from the normalizer and all of the serially-connected delay units; a first determining unit configured to make a packet discovery determination on the basis of the result of comparing the first normalized autocorrelation sum output by the first summing unit to a first autocorrelation threshold value; a second summing unit configured to calculate the sum of the normalized autocorrelations respectively output from the normalizer and a predetermined number of serially-connected delay units starting from the first; a second determining unit configured to make a packet discovery announcement determination on the basis of the result of comparing the second normalized autocorrelation sum output by the second summing unit to a second autocorrelation threshold value lower than the first autocorrelation threshold value; and a packet discovery announcement processor configured to conduct predetermined processing in accordance with the packet discovery announcement determination made by the second determining unit.

In addition, in either of the above wireless communication apparatus in accordance with embodiments of the present invention, the packet discovery announcement processor may, in accordance with the packet discovery announcement, output a CCA signal from the physical layer to the MAC layer or lock the AGC gain in the receiver.

A wireless communication method in accordance with another embodiment of the present invention includes the steps of: receiving a packet wherein a preamble made up of an established, repeating training sequence has been added to the beginning thereof; calculating a first autocorrelation of a received signal over a first interval; making a packet discovery determination on the basis of the result of comparing the first autocorrelation calculated in the first autocorrelation calculating step to a first autocorrelation threshold value; calculating a second autocorrelation of the received signal over a second interval equivalent to the interval length for packet discovery announcement; making a packet discovery announcement determination on the basis of the result of comparing the second autocorrelation computed in the second autocorrelation calculating step to a second autocorrelation threshold value lower than the first autocorrelation threshold value; and conducting predetermined processing in accordance with the packet discovery announcement determination made in the packet discovery announcement determining step.

A wireless communication method in accordance with another embodiment of the present invention includes the steps of: receiving a packet wherein a preamble made up of an established, repeating training sequence has been added to the beginning thereof; calculating the autocorrelation of a received signal for each repeating period of the established training sequence; normalizing the autocorrelation computed in the autocorrelation calculating to the average received signal power in a given interval; calculating a first sum of the normalized autocorrelation obtained in the normalizing step and a number of delay signals wherein the normalized autocorrelation is successively delayed by one repeating period of the established training sequence, and wherein the number of delay signals is equal to the number of times the established training sequence is repeated; making a packet discovery determination on the basis of the result of comparing the first normalized autocorrelation sum computed in the first summing step to a first autocorrelation threshold value; calculating a second sum of the normalized autocorrelation obtained in the normalizing step and a number of delay signals wherein the normalized autocorrelation is successively delayed by one repeating period of the established training sequence, up to a delay time corresponding to the interval length for packet discovery announcement; and making a packet discovery announcement determination on the basis of the result of comparing the second normalized autocorrelation sum computed in the second summing step to a second autocorrelation threshold value lower than the first autocorrelation threshold value.

A computer program in accordance with another embodiment of the present invention is stated in a computer-readable format so as to execute, on a computer, processing to detect a packet from a received signal by using a preamble made up of an established, repeating training sequence added to the beginning of the packet. The computer program causes the computer to execute the steps of: calculating a first autocorrelation of the received signal over a first interval; making a packet discovery determination on the basis of the result of comparing the first autocorrelation computed in the first autocorrelation calculating step to a first autocorrelation threshold value; calculating a second autocorrelation of the received signal over a second interval equivalent to the interval length for packet discovery announcement; and making a packet discovery announcement determination on the basis of the result of comparing the second autocorrelation computed in the second autocorrelation calculating step to a second autocorrelation threshold value lower than the first autocorrelation threshold value.

In addition, a computer program in accordance with another embodiment of the present invention is stated in a computer-readable format so as to execute, on a computer, processing to detect a packet from a received signal by using a preamble made up of an established, repeating training sequence added to the beginning of the packet. The computer program causes the computer to execute the steps of: calculating the autocorrelation of the received signal for each repeating period of the established training sequence; normalizing the autocorrelation computed in the autocorrelation calculating step to the average received signal power in a given interval; calculating a first sum of the normalized autocorrelation obtained in the normalizing step and a number of delay signals wherein the normalized autocorrelation is successively delayed by one repeating period of the established training sequence, and wherein the number of delay signals is equal to the number of times the established training sequence is repeated; making a packet discovery determination on the basis of the result of comparing the first normalized autocorrelation sum computed in the first summing step to a first autocorrelation threshold value; calculating a second sum of the normalized autocorrelation obtained in the normalizing step and a number of delay signals wherein the normalized autocorrelation is successively delayed by one repeating period of the established training sequence, up to a delay time corresponding to the interval length for packet discovery announcement; and making a packet discovery announcement determination on the basis of the result of comparing the second normalized autocorrelation sum computed in the second summing step to a second autocorrelation threshold value lower than the first autocorrelation threshold value.

The above computer programs in accordance with embodiments of the present invention are respectively defined to be computer programs stated in a computer-readable format so as to realize predetermined processing on a computer. In other words, the above computer programs in accordance with embodiments of the present invention may be installed onto a computer and thereby exhibit cooperative action on the computer such that advantages are obtained similar to those of the packet detection apparatus in accordance with other embodiments of the present invention described above.

According to embodiments of the present invention, a packet detection apparatus and method, a wireless communication apparatus and method, and a computer program are provided whereby packet discovery is conducted by autocorrelation of an established training sequence repeatedly contained in the preamble.

In addition, according to embodiments of the present invention, a packet detection apparatus and method, a wireless communication apparatus and method, and a computer program are provided whereby clear channel assessment and AGC gain locking is suitably conducted in accordance with packet discovery.

In addition, in accordance with embodiments of the present invention, a packet detection apparatus and method, a wireless communication apparatus and method, and a computer program are provided whereby clear channel assessment and AGC gain locking is suitably conducted in a short amount of time from the beginning of the packet.

According to the first through the third, fifth, sixth, eighth, ninth, 15th, and 16th embodiments of the present invention, noise and non-IEEE 802.11a/n signals are less likely to appear in the packet discovery announcement signal. Consequently, by providing a receiver with a packet detection apparatus in accordance with an embodiment of the present invention, it becomes possible to reduce transmission suppression due to excessive CCA and improve the actual throughput. Moreover, the accuracy of packet discovery announcement timing with respect to IEEE 802.11a/n signals can be improved.

According to the fourth and seventh embodiments of the present invention, a packet discovery announcement can be simultaneously output together with packet discovery, even in the unlikely case that a packet discovery announcement determination is not made in a short amount of time at the beginning of the packet. Consequently, even if the packet discovery announcement fails, a CCA signal is still reliably output from the physical layer to the MAC layer, and in addition, the AGC gain is reliably locked.

In addition, according to the 10th to the 14th embodiments of the present invention, noise and non-IEEE 802.11a/n signals are less likely to appear in the packet discovery announcement signal. Consequently, it becomes possible to reduce transmission suppression due to excessive CCA and improve the actual throughput. Moreover, the accuracy of packet discovery announcement timing with respect to IEEE 802.11a/n signals can be improved. As a result, the reliability of the packet discovery announcement as an index for locking the AGC gain is improved, and both AGC gain adjustment and DC offset correction can be reliably completed within the STF interval. In so doing, upon arrival of the subsequent LTF interval wherein frequency offsets and channels are estimated, signals are ready to be received with reliably and optimally adjusted AGC gain and corrected DC offsets. For this reason, adverse effects on frequency offset and channel estimation are eliminated, and decoding error is less likely.

Further features and advantages of the present invention will become apparent upon reading of the following detailed description of exemplary embodiments in conjunction with the attached drawings.

### BRIEF DESCRIPTION OF THE DRAWINGS

FIG. 1 illustrates an exemplary configuration of the transmitting system of a MIMO communication apparatus;

FIG. 2 illustrates an exemplary configuration of the receiving system of an MIMO communication apparatus;

FIG. 3 illustrates an exemplary configuration inside an RF unit 230 in each receive branch;

FIG. 4 illustrates an exemplary configuration of a control loop for control by an AGC amp 33 in the digital domain;

FIG. 5 illustrates a packet format in the legacy mode of IEEE 802.11n;

FIG. 6 illustrates a packet format in the legacy mode of IEEE 802.11n;

FIG. 7 illustrates a functional configuration for conducting both packet discovery and packet discovery announcement in a synchronizing circuit 222;

FIG. 8 illustrates an output chart of each functional module shown in FIG. 7;

FIG. 9 illustrates another exemplary configuration for conducting both packet discovery and packet discovery announcement in the synchronizing circuit 222;

FIG. 10 illustrates how delay is successively applied to the normalized moving average in units of the repeating period (0.8 microseconds) by the eight delay units 909 to 916;

FIG. 11 illustrates an exemplary waveform of the normalized autocorrelation in the case of residual packet pre-arrival noise;

FIG. 12 illustrates an exemplary waveform 1210 of the normalized autocorrelation output from the second summing unit 919, as well as a threshold value 1212 for packet discovery announcement; and

FIG. 13 illustrates the structure of a preamble as stipulated by IEEE 802.11a/g.

### DESCRIPTION OF THE PREFERRED EMBODIMENTS

Hereinafter, embodiments of the present invention will be described in detail and with reference to the attached drawings.

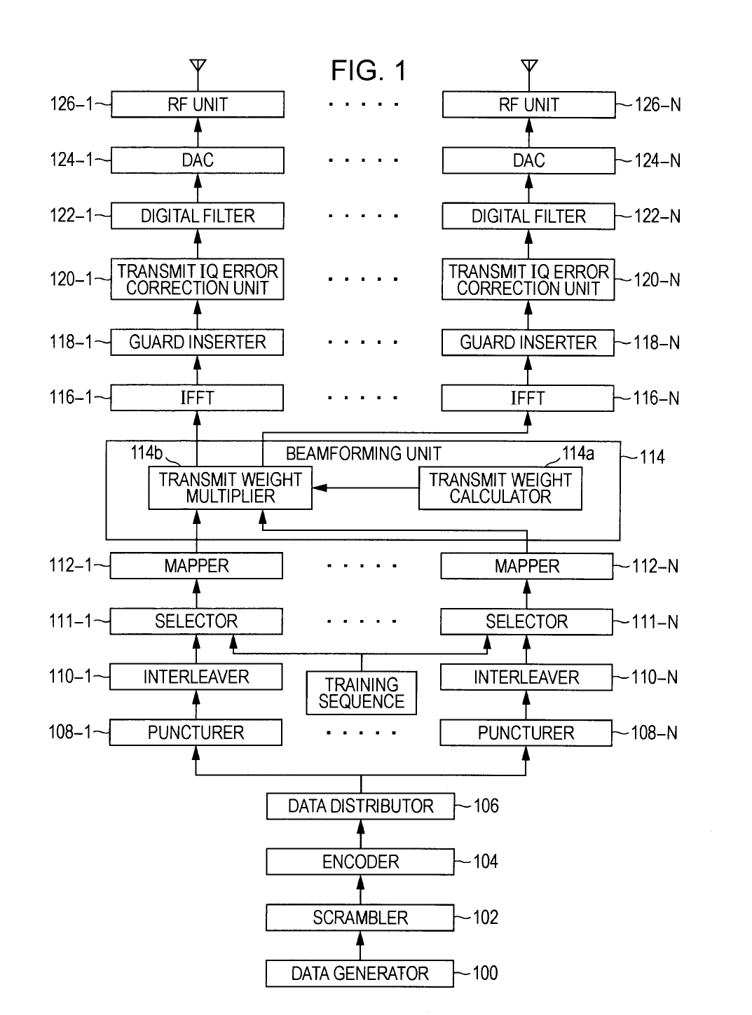

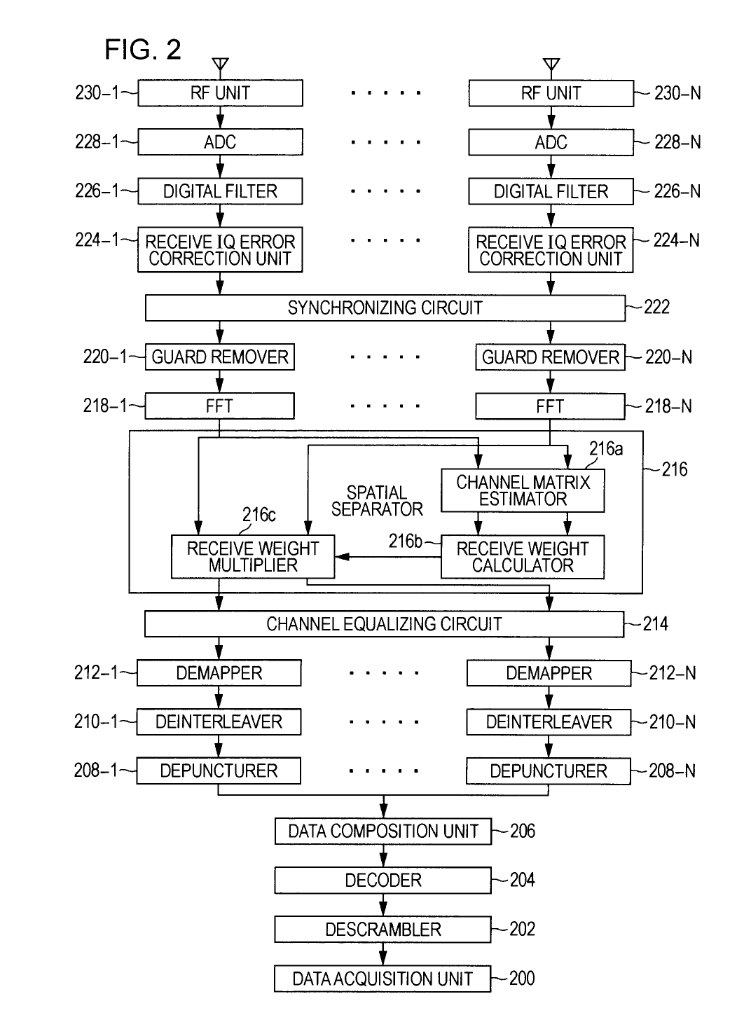

FIGS. 1 and 2 respectively illustrate exemplary configurations of the transmitting system and the receiving system of a wireless communication apparatus in accordance with an embodiment of the present invention. Herein, a MIMO communication device provided with a plurality of antennas and conducting transmit beamforming in accordance with channel characteristics is adopted. However, it should be appreciated that the present invention is not limited thereto. (For example, an embodiment of the present invention may also be applied to a Single-Input and Single-Output (SISO) communication device provided with single transmit and receive antennas.)

First, the configuration of the transmitting system will be described with reference to FIG. 1. Herein, the transmitting system is assumed to operate as a beamformer that transmits by first conducting beamforming using a plurality of transmit streams.

Transmit data supplied from a data generator 100 is first scrambled in a scrambler 102. The resulting data is then encoded using error correction coding by an encoder 104. The scrambling and encoding methods follow those defined in IEEE 802.11a, for example. Subsequently, the encoded signal is input into a data distributor 106 and distributed across respective transmit streams.

In each transmit stream, the transmit signal is punctured by a puncturer 108 in accordance with the data rate provided to each stream, and then interleaved by an interleaver 110. The data is then mapped by a mapper 112 into an I-Q signal space made up of in-phase (I) and quadrature-phase (Q) components, thereby resulting in a complex baseband signal. A selector 111 also inserts training sequences at suitable timings into the transmit signals in each interleaved spatial stream, and supplies the result to the mapper 112. The interleaving method may extend that defined in IEEE 802.11a, for example, such that the same interleave is not used among multiple streams. The mapping method also follows IEEE 802.11a, and BPSK, QPSK, 16-QAM, or 64-QAM may be applied thereto.

In a beamforming unit 114, a transmit weight matrix calculator 114A may use singular value decomposition (SVD), eigenvalue decomposition (EVD), or another matrix decomposition technique to obtain a transmit beamforming matrix for applying weights to each transmit antenna and conducting beamforming at the time of transmission. Subsequently, a transmit weight matrix multiplier 114B conducts beamforming by using the transmit beamforming matrix computed by the transmit weight matrix calculator 114A to digitally weight each transmit antenna and vary the antenna directionality, thereby enabling the communication partner (i.e., the receiver) to receive with high quality.

In an inverse fast Fourier transform unit 116, respective sub-carriers arranged in the frequency domain are converted into a time-axis signal, to which guard intervals are added by a guard inserter 118.

A transmit IQ error correction unit 120 then conducts IQ error correction. The IQ error referred to herein is made up of two components: IQ amplitude error due to amplitude fluctuations between the I channel signal and the Q channel signal in the IQ modulator of the upconverter, and IQ phase error occurring when the I axis and the Q axis are misaligned from 90°. If left uncorrected, such IQ error adversely affects the error vector magnitude (EVM) of the transmit signal, thereby leading to reduced data transfer quality.

Subsequently, after being band-limited by a digital filter 122, the signal is converted into an analog signal by a DA converter (DAC) 124. In an RF unit 126, an analog LPF is used to remove all signal components outside the passband. The remaining center frequencies are then upconverted to the RF frequency band by a quadrature modulator (i.e., an IQ modulator), and the signal amplitude is also amplified by power amplification. The transmit signal thus converted to the RF band is then broadcast from the respective transmit antennas.

The configuration of the receiving system will now be described with reference to FIG. 2. Herein, the receiving system is assumed to operate as a beamformee that receives a plurality of signals that have been subjected to transmit beamforming.

First, beamformed transmit signals arrive from a communication partner having a plurality of transmit antennas. The signals arriving at each receive antenna are first subjected to analog processing in each receive antenna branch by an RF unit 230.

The analog receive signals are then converted into digital signals by an AD converter (ADC) 228, input into a digital filter 226, and band-limited.

A receive IQ error correction unit 224 then conducts IQ error correction. The IQ error referred to herein is made up of two components: IQ amplitude error due to amplitude fluctuations between the I channel signal and the Q channel signal in the IQ demodulator of the downconverter, and IQ phase error occurring when the I axis and the Q axis are misaligned from 90°. If left uncorrected, such IQ error adversely affects the error vector magnitude (EVM) of the receive signals, thereby leading to reduced data transfer quality.

Subsequently, in a synchronizing circuit 222, processing such as packet discovery, timing detection, frequency offset correction, and noise estimation is conducted. In the synchronizing circuit 222 of the present embodiment, a packet discovery announcement is also conducted before the packet discovery determination (specifically, within 4 microseconds from the beginning of the packet). Further details will be later given.

In a guard remover 220, the guard intervals added to the beginning of the data transmit intervals are removed. Subsequently, the time-axis signals are converted into frequency-axis signals by a fast Fourier transform (FFT) unit 218.

In a spatial separator 216, processing is conducted to spatially separate the beamformed receive signals. More specifically, a channel matrix estimator 216A assembles an estimated channel matrix H from the training sequences received on each receive branch, the training sequences herein being used to excite the channel matrix. An antenna receive weight matrix calculator 216B then calculates an antenna receive weight matrix W on the basis of the forward-direction channel matrix H obtained by the channel matrix estimator 216A. Subsequently, an antenna receive weight matrix multiplier 216C spatially decodes the beamformed, spatially multiplexed signal by matrix multiplying the antenna receive weight matrix W by a receive vector having respective receive streams as its elements. Independent, per-stream signal sequences are obtained as a result. Herein, a minimum mean square error (MMSE) algorithm is used as the method for calculating the antenna receive weight matrix W, but obviously a matrix decomposition technique such as SVD or EVD may also be used.

A channel equalizing circuit 214 then performs additional offset correction for residual frequencies, channel tracking, and other operations with respect to the per-stream signal sequences. Subsequently, a demapper 212 demaps the receive signal in I-Q signal space, a deinterleaver 210 deinterleaves the receive signal, and a depuncturer 208 depunctures the receive signal at a predetermined data rate.

A data composition unit 206 composites the plurality of receive streams into a single stream. The data composition processing at this point conducts operations that are the exact reverse of the data distribution conducted on the transmit side. After subsequently decoding the stream using error correction decoding by a decoder 204, the stream is descrambled by a descrambler 202, and a data acquisition unit 200 then acquires the receive data.

The PHY layer of IEEE 802.11n wherein MIMO communication is adopted is provided with a high throughput (HT) transmission mode (hereinafter referred to as HT mode) whose modulation and coding scheme (MSC) is completely different from that of the earlier IEEE 802.11a/g standards. In addition, the PHY layer of IEEE 802.11n is also provided with an operational mode whereby data transmission is conducted using the same packet format and frequency domain as that of the earlier IEEE 802.11a/g standards (hereinafter referred to as legacy mode). Furthermore, the HT mode also includes an operational mode referred to as mixed mode (MM), which is compatible with a client compliant with IEEE 802.11a/g (hereinafter referred to as a legacy client).

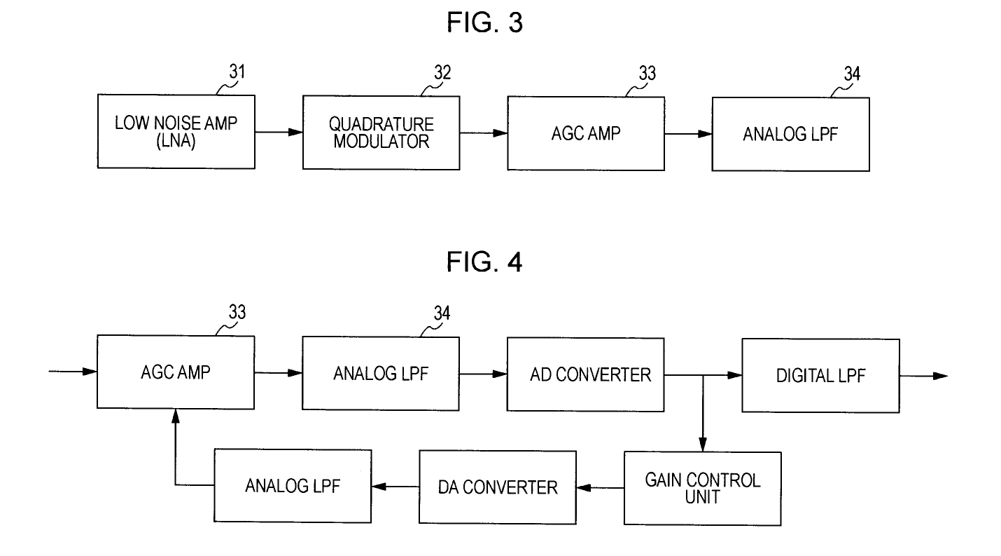

FIG. 3 illustrates an exemplary configuration inside the RF unit 230 on each receive branch. The RF unit 230 shown in FIG. 3 includes a low noise amp (LNA) 31, an IQ demodulator that downconverts a receive signal in the RF frequency band, an AGC amp 33 that normalizes the receive signal power so as to be contained in the dynamic range of the AD converter 228, and an analog low-pass filter (LPF) 34 that removes all signal components outside a given passband. In addition, FIG. 4 illustrates an exemplary configuration of a control loop for control by the AGC amp 33 in the digital domain. Gain control is performed after digital conversion by the AD converter (ADC). A gain control unit then computes the degree of amplification to be used in the AGC amp, on the basis of the receive signal amplitude. The receive signal power is then computed from the receive signal amplitude. Subsequently, the signal is reverted to an analog signal by a DA converter (DAC), passed through an analog low-pass filter (LPF), and then fed back into the AGC amp. However, if the AGC gain is locked, then all processing is stopped at the gain control unit, and the output signal for the gain control that was last output is held. In the present embodiment, the AGC gain is locked in response to a packet discovery announcement made during synchronization processing. Further details regarding the packet discovery announcement will be later given.

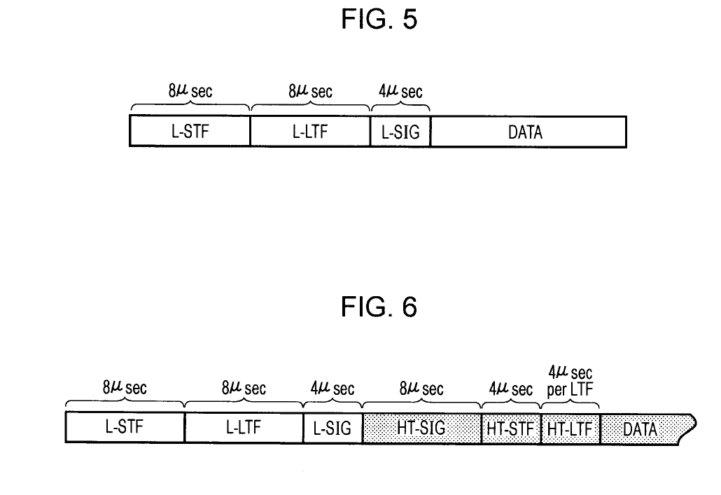

FIGS. 5 and 6 respectively illustrate the packet formats used in legacy mode and the respective MM operational modes. In FIGS. 5 and 6, one OFDM symbol is taken to be 4 microseconds long.

A packet in the legacy mode shown in FIG. 5 (hereinafter referred to as a legacy packet) has a format identical to that of IEEE 802.11a/g. The legacy packet header has a legacy preamble containing a legacy STF (L-STF) made up of established training symbols STS for packet discovery, a legacy LTF (L-LTF) made up of repeating, established training symbols LTS for synchronization and channel equalization, and a legacy signal field (L-SIG) stating the transmission rate and data length. The legacy preamble is transmitted followed by the payload (data).

The header of a packet as shown in FIG. 6 (hereinafter referred to as an MM packet) includes a legacy preamble in a format identical to that of IEEE 802.11a/g, followed by a preamble in a format specific to IEEE 802.11n (hereinafter referred to as an HT preamble), and a data portion. The MM packet includes a portion in HT format that corresponds to the PHY payload in a legacy packet. In the HT format, it is possible to recursively structure a packet with an HT preamble and a PHY payload.

The HT preamble contains an HT-SIG, an HT-STF, and an HT-LTF. The HT-SIG states information used to interpret the HT format, such as the MCS to be applied to the PHY payload (PSDU) and the data length of the payload. The HT-STF is made up of training symbols for improving automatic gain control (AGC) in the MIMO system. The HT-LTF is made up of training symbols for estimating the channel for each input signal mapped at the receiver.

In the case of MIMO communication using two or more transmit branches, the channel for each transmit and receive antenna is estimated at the receiver to acquire a channel matrix for spatially separating the received signal. For this reason, the transmitter is configured to transmit the HT-LTF from each transmit antenna by time division. Consequently, one or more HT-LTF fields are added in accordance with the number of spatial streams.

The legacy preamble in a MM packet has a format identical to that of a legacy packet preamble (see FIG. 13), and in addition, is transmitted so as to be decodable by legacy clients. In contrast, the HT format portion beginning with the HT preamble is transmitted by a method incompatible with legacy clients.

In either of the above packet formats shown in FIGS. 5 and 6, the beginning of the packet contains the legacy preamble shown in FIG. 13. The synchronizing circuit 222 is thus able to both conduct packet discovery and packet discovery announcement by taking the autocorrelation of the L-STF portion made up of a repeating sequence of 10 established STSs lasting 0.8 microseconds each.

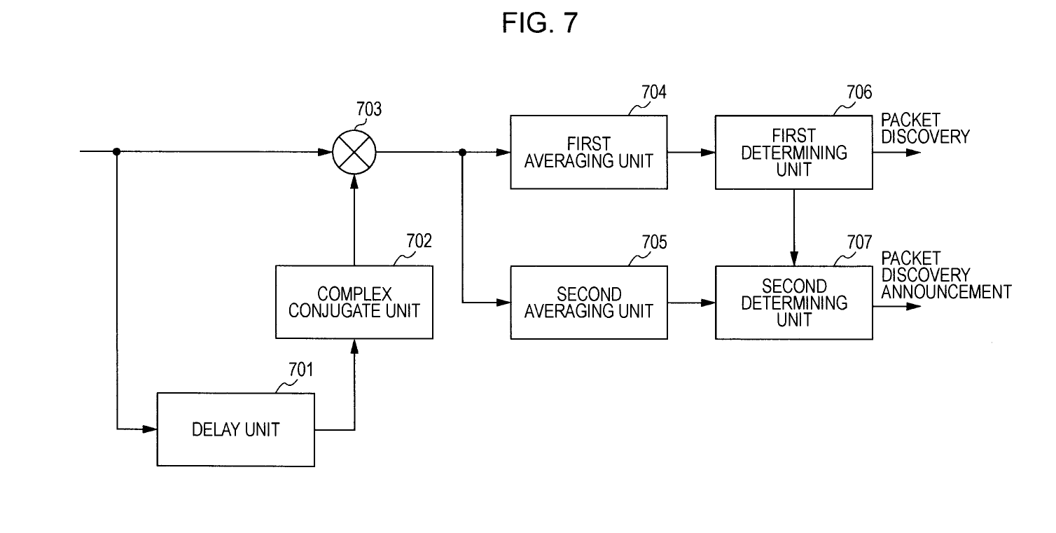

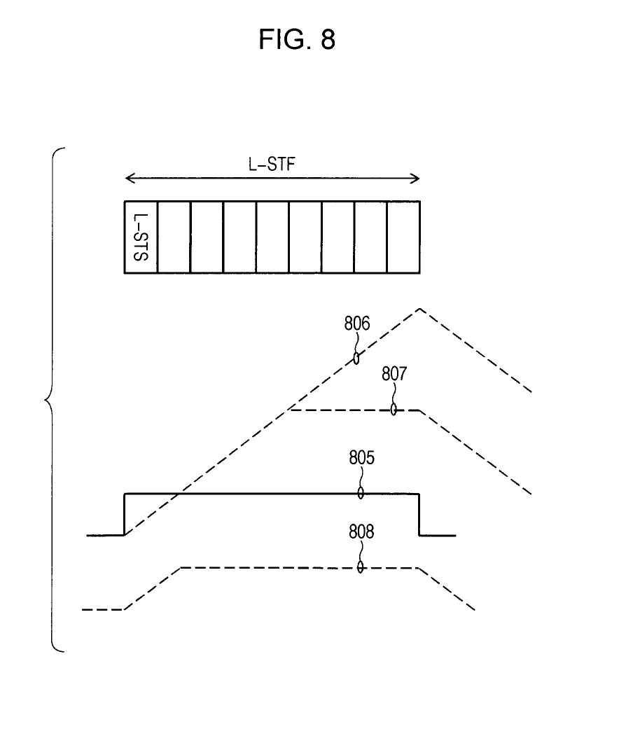

FIG. 7 illustrates a functional configuration for conducting packet discovery and packet discovery announcement in the synchronizing circuit 222. In addition, FIG. 8 illustrates an output chart of each functional module shown in FIG. 7.

The delay unit 701 holds a received signal at a 0.8 microsecond interval corresponding to the repeating period of the established STS, and then outputs the result as a delay signal. The complex conjugate unit 702 takes the complex conjugate of the delay signal. Subsequently, the multiplier 703 conducts complex conjugate multiplication of the received signal and the delay signal that has been delayed by one interval of the repeating period of the established STS (i.e., 0.8 microseconds).

The first averaging unit 704 solves for an autocorrelation value by calculating the moving average of the product output by the multiplier 703, using the entire L-STF interval as the moving average interval. The first determining unit 706 then discovers a packet when the autocorrelation value exceeds a predetermined threshold value.

Herein, the results output by the multiplier 703 for the complex conjugate multiplication of the received signal and the delay signal yield the rectangular shape shown by the line labeled 805 in FIG. 8. The fixed value starts 0.8 microseconds after repetition of the established STS in the L-STF is initiated and lasts for 8.0 microseconds, at which point the L-STF ends. When the first averaging unit 704 calculates a 7.2 microsecond moving average corresponding to the above interval, the above rectangular shape is integrated, and becomes the triangular shape shown by the line labeled 806 in FIG. 8. Consequently, the first determining unit 706 is able to made a packet discovery determination by comparing the moving average for the L-STF interval length to a threshold value.

In addition, the synchronizing circuit 222 is configured to make a packet discovery announcement before a packet discovery determination is made, which triggers the outputting of a CCA signal within 4 microseconds from the beginning of the packet, as well as the locking of the AGC gain. More specifically, the second averaging unit 705 calculates the autocorrelation by taking the moving average of the results for the complex conjugate multiplication of the received signal and a delay signal with a 0.8 microsecond interval. The second determining unit 707 makes a packet discovery announcement determination using autocorrelation by comparing the autocorrelation value to a threshold value. The packet discovery announcement then triggers the output of a CCA signal from the physical layer to the MAC layer and the locking of the AGC gain.

Herein, conducting a packet discovery announcement within 4 microseconds and before the packet discovery determination is possible as a result of the following. First, the second averaging unit 705 calculates the autocorrelation by taking the moving average of the results for the complex conjugate multiplication of the received signal and the delay signal, using the entire L-STF interval as the moving average interval, similarly to packet discovery. The second determining unit 707 then compares the autocorrelation value to a separate threshold value lower than that used for packet discovery. However, the first half of the 8 microsecond moving average interval (i.e., the first 4 microseconds from the beginning of the packet) is the packet pre-arrival noise interval. In other words, if the results for the complex conjugate multiplication of a received signal and a delay signal derived from a portion lasting 4 microseconds from the beginning of the packet is simply input into the second averaging unit 705, results will remain for complex conjugate multiplication evaluated over an interval for which at least half is a packet pre-arrival noise interval. If the autocorrelation for the first 4 microseconds from the beginning of the packet is compared to a low threshold value, then a packet discovery announcement signal will more readily occur for noise and non-IEEE 802.11a/n signals, making error more likely.

Consequently, in order to make an accurate packet discovery announcement within 4 microseconds, the second averaging unit 705 calculates the moving average with a short moving average interval in accordance with the short amount of time (4 microseconds) within which a packet discovery announcement is desired. The second determining unit 707 then compares the moving average value to a threshold value for packet discovery announcement that is lower than the threshold value for packet discovery used by the first determining unit 406. In the first 4 microseconds from the beginning of the packet, the results for the complex conjugate multiplication of a received signal and a delay signal derived from a portion lasting 4 microseconds from the beginning of the packet are input into the second averaging unit 705, and the results for complex conjugate multiplication evaluated over the packet pre-arrival noise interval do not remain therein. Consequently, a packet discovery announcement signal less readily occurs for noise and non-IEEE 802.11a/n signals.

If the second averaging unit 705 calculates a moving average with a moving average interval shorter than the length of the preamble interval, then the rectangular shape labeled 805 in FIG. 8 does not become the triangular shape 806 (see above). Instead, the average values reach an intermediate table shape, as shown by the line labeled 807 in FIG. 8. FIG. 8 demonstrates that the height of the table shape 807 is lower than the peak of the triangular shape 806. For this reason, the second determining unit 707 is configured such that the threshold value for packet discovery announcement does not fall below the upper base of the table shape 807, in order to prevent missed announcements.

In the unlikely case that the threshold value for packet discovery announcement does not reach the upper base of the table shape 807, a packet discovery announcement will not be output from the second determining unit 707. In order to cope with such a situation, the first determining unit 706 may be configured to output a packet discovery announcement simultaneously with packet discovery when packet discovery has been determined but a packet discovery announcement has not yet been output from the second determining unit 707. In so doing, a CCA signal is reliably output from the physical layer to the MAC layer, even if the second determining unit 707 fails to make a packet discovery announcement. Moreover, the receiver can be configured such that the AGC gain is reliably locked. In FIG. 7, the arrow pointing from the first determining unit 706 to the second determining unit 707 corresponds to a signal line for confirming whether or not the second determining unit 707 has made a packet discovery announcement determination.

In this way, if packet discovery and packet discovery announcement are conducted by the synchronizing circuit 222 shown in FIG. 7, a packet discovery announcement signal is less likely to occur to noise and non-IEEE 802.11a/n signals. For this reason, it is possible to reduce excessive transmission suppression by CCA and improve actual throughput. Moreover, the accuracy of packet discovery announcement timing with respect to IEEE 802.11a/n signals can be improved.

As a result, the reliability of the packet discovery announcement as an index for locking the AGC gain is improved, and both AGC gain adjustment and DC offset correction can be reliably completed within the L-STF interval. In so doing, upon arrival of the subsequent L-LTF interval wherein frequency offsets and channels are estimated, signals are ready to be received with reliably and optimally adjusted AGC gain and corrected DC offsets. For this reason, adverse effects on frequency offset and channel estimation are eliminated, and decoding error is less likely.

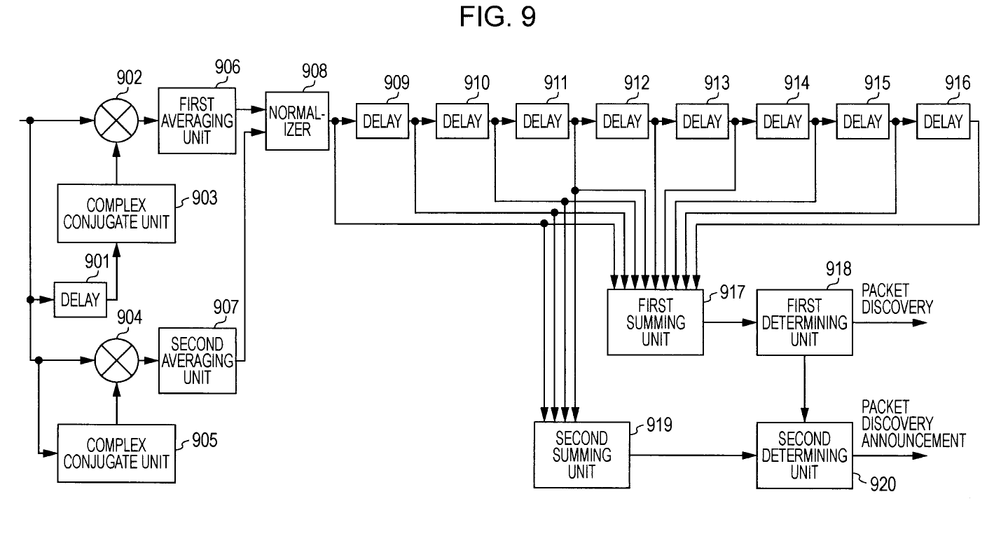

FIG. 9 illustrates another exemplary configuration for conducting both packet discovery and packet discovery announcement in the synchronizing circuit 222.

The delay unit 901 holds a received signal at a 0.8 microsecond interval corresponding to the repeating period of the established STS, and then outputs the result as a delay signal. The complex conjugate unit 903 takes the complex conjugate of the delay signal output by the delay unit 901. The multiplier 902 then conducts complex conjugate multiplication of the received signal and the delay signal that has been delayed by one interval of the repeating period of the established STS (i.e., 0.8 microseconds). Subsequently, the first averaging unit 906 solves for a moving average, using one repeating period of the established STS as the moving average interval. The moving average for one repeating period is shown by the line labeled 808 in FIG. 8, becoming a table shape lower than the moving average taken over the 4 microsecond interval corresponding to five repeating periods, as shown by the line labeled 807 in FIG. 8.

Meanwhile, the complex conjugate unit 905 takes the complex conjugate of the received signal, and the multiplier 904 solves for the received signal power by conducting complex conjugate multiplication of the received signal with itself. Subsequently, the second averaging unit 907 takes a moving average over an interval of two repeating periods of the established STS, and thereby solves for the average received signal power (i.e., the moving average of the square of the received signal sample).

The normalizer 908 successively normalizes the autocorrelation output from the first averaging unit 906 to the average received signal power output from the second averaging unit 907. Although the receiver is standing by to receive a signal with the AGC gain maximized, the normalization processing conducted at this point enables the receiver to eliminate the effects of AGC gain fluctuations at the beginning of the packet.

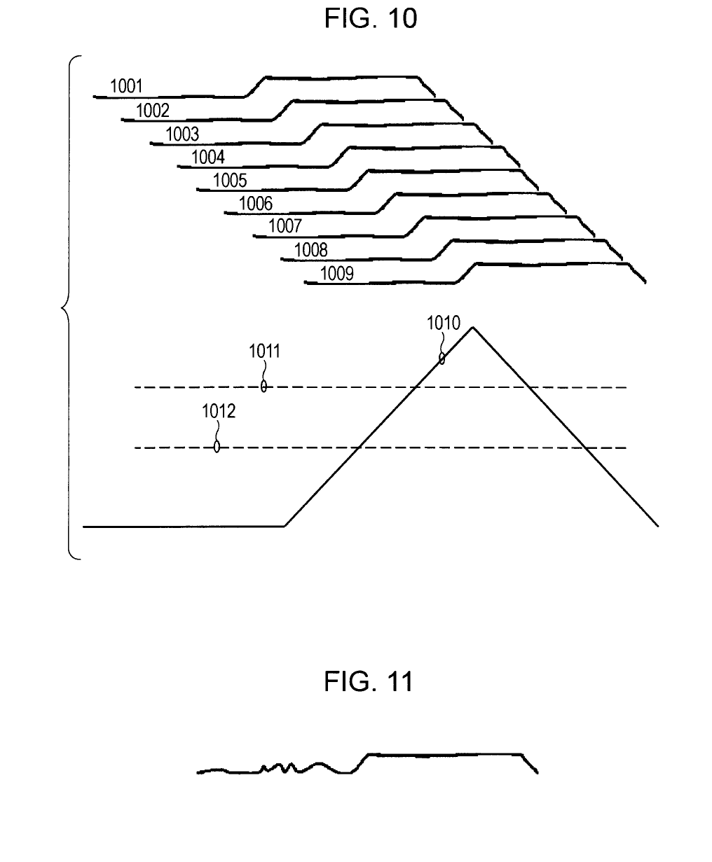

The following eight, serially-connected delay units 909 to 916 are made up of delay elements respectively having delay times of 0.8 microseconds, corresponding to the repeating period of the established STS. The number of delay units 909 to 916 corresponds to the number of times the established training sequence is repeated. FIG. 10 illustrates how delay is successively applied to the normalized moving average (having a moving average interval equal to one repeating period) in units of the repeating period (0.8 microseconds) by the eight delay units 909 to 916. The line labeled 1001 in FIG. 10 represents the output of the normalizer 908, while the lines labeled 1002 to 1009 represent the output of the respective delay units 909 to 916.

The first summing unit 917 computes the sum of the outputs 1001 to 1009 from the normalizer 908 and all of the delay units 909 to 916. This sum value corresponds to solving for the normalized autocorrelation using the entire L-STF interval as the moving average interval, and becomes a triangular shape as shown by the line labeled 1010 in FIG. 10. Consequently, the first determining unit 918 is able to make a packet discovery determination by comparing the output of the first summing unit 917 to a threshold value (represented by the line labeled 1011 in FIG. 10).

In addition, the synchronizing circuit 222 makes a packet discovery announcement before a packet discovery determination is made. The packet discovery announcement thus triggers the output of a CCA signal from the physical layer to the MAC layer and the locking of the AGC gain.

Herein, conducting a packet discovery announcement within 4 microseconds and before the packet discovery determination can be achieved by a method wherein the normalized autocorrelation having the triangular waveform and output by the first summing unit 917 is compared to a threshold value for packet discovery announcement. The threshold value for packet discovery announcement, shown as the line labeled 1012 in FIG. 10, is lower than the threshold value for packet discovery, shown as the line labeled 1011. However, the first half of the 8 microsecond moving average interval (i.e., the first 4 microseconds from the beginning of the packet) is the packet pre-arrival noise interval. In other words, if the results for the complex conjugate multiplication of a received signal and a delay signal derived from a portion lasting 4 microseconds from the beginning of the packet is simply input into the normalizer 908, results will remain for complex conjugate multiplication evaluated over an interval for which at least half is a packet pre-arrival noise interval. FIG. 11 illustrates an exemplary waveform of the normalized autocorrelation in the case where packet pre-arrival noise remains. As shown in FIG. 11, a normalized noise waveform precedes the low, table-shaped waveform that corresponds to normalized autocorrelation results for one repeating period of the original signal. If such noise components are included in the sum of the output of all delay units 909 to 916, then the level of the normalized autocorrelation of the noise component portion also becomes high, and there is a possibility that the low threshold value indicated by the line labeled 1012 will be exceeded, leading to error.

Consequently, in order to make an accurate packet discovery announcement within 4 microseconds, the second summing unit 919 computes the sum of output 1001 of the normalizer 908 and the outputs 1002 to 1004 of the first three delay units 909 to 911. The total delay time in the output of the last delay unit 911 is within 4 microseconds from the beginning of the packet, and corresponds to the second summing unit 919 solving for the normalized autocorrelation using the interval length suitable for packet discovery announcement as the moving average interval. In the first 4 microseconds from the beginning of the packet, the results for the complex conjugate multiplication of a received signal and a delay signal derived from a portion lasting 4 microseconds from the beginning of the packet are input into the normalizer 908, and the results for complex conjugate multiplication evaluated over the packet pre-arrival noise interval do not remain therein. Consequently, a packet discovery announcement signal less readily occurs for noise and non-IEEE 802.11a/n signals.

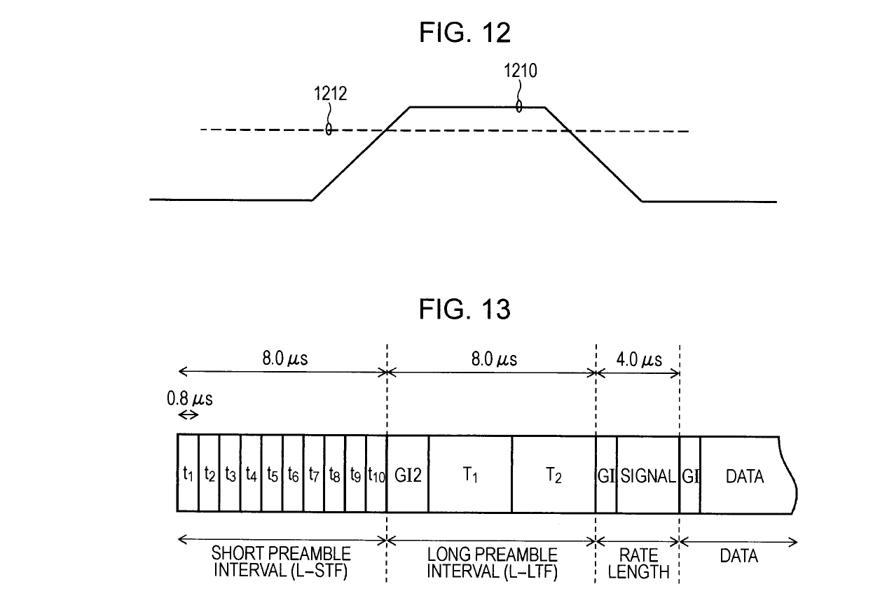

If the second summing unit 919 computes the sum of the output 1001 of the normalizer 908 and the outputs 1002 to 1004 of the first three delay unit 909 to 911, then the normalized autocorrelation does not become the triangular shape 1010, but instead reaches an intermediate table shape, as shown by the line labeled 1210 in FIG. 12. The height of the table shape 1210 is lower than the peak of the triangular shape 1010. For this reason, the second determining unit 920 is configured such that the threshold value 1212 for packet discovery announcement does not fall below the upper base of the table shape 1210, in order to prevent missed announcements.

In the unlikely case that the threshold value 1212 for packet discovery announcement does not reach the upper base of the table shape 1210, a packet discovery announcement will not be output from the second determining unit 920. In order to cope with such a situation, the first determining unit 918 may be configured to output a packet discovery announcement simultaneously with packet discovery when packet discovery has been determined but a packet discovery announcement has not yet been output from the second determining unit 920. In so doing, a CCA signal is reliably output from the physical layer to the MAC layer, even if the second determining unit 920 fails to make a packet discovery announcement. Moreover, the receiver can be configured such that the AGC gain is reliably locked. In FIG. 9, the arrow pointing from the first determining unit 918 to the second determining unit 920 corresponds to a signal line for confirming whether or not the second determining unit 920 has made a packet discovery announcement determination.

In this way, if packet discovery and packet discovery announcement are conducted by the synchronizing circuit 222 shown in FIG. 9, a packet discovery announcement signal is less likely to occur for noise and non-IEEE 802.11a/n signals. For this reason, it is possible to reduce excessive transmission suppression by CCA and improve actual throughput. Moreover, the accuracy of packet discovery announcement timing with respect to IEEE 802.11a/n signals can be improved.

As a result, the reliability of the packet discovery announcement as an index for locking the AGC gain is improved, and both AGC gain adjustment and DC offset correction can be reliably completed within the L-STF interval. In so doing, upon arrival of the subsequent L-LTF interval wherein frequency offsets and channels are estimated, signals are ready to be received with reliably and optimally adjusted AGC gain and corrected DC offsets. For this reason, adverse effects on frequency offset and channel estimation are eliminated, and decoding error is less likely.

The present application contains subject matter related to that disclosed in Japanese Priority Patent Application JP filed in the Japan Patent Office on Aug. 6, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A packet detection apparatus that detects a packet from a received signal by using a preamble made up of an established, repeating training sequence added to the beginning of the packet, the packet detection apparatus comprising:
a first autocorrelation calculator configured to solve for a first autocorrelation of the received signal over a first interval;
a first determining unit configured to make a packet discovery determination on the basis of the result of comparing the first autocorrelation computed by the first autocorrelation calculator to a first autocorrelation threshold value;
a second autocorrelation calculator configured to solve for a second autocorrelation of the received signal over a second interval equivalent to the interval length for packet discovery announcement; and
a second determining unit configured to make a packet discovery announcement determination on the basis of the result of comparing the second autocorrelation computed by the second autocorrelation calculator to a second autocorrelation threshold value lower than the first autocorrelation threshold value.

2. The packet detection apparatus according to claim 1, wherein the first interval is equivalent to the preamble interval length, and the second interval is shorter than the first interval.

3. The packet detection apparatus according to claim 1, wherein the first and the second autocorrelation calculators respectively compute moving averages of the complex conjugate multiplication results for the received signal and a delay signal received earlier by one repeating period of the training sequence in the first and second intervals.

4. The packet detection apparatus according to claim 1, wherein the first determining unit additionally makes a packet discovery announcement if the second determining unit has not yet made a packet discovery announcement determination at the time of the first determining unit determining packet discovery.

5. A packet detection apparatus that detects a packet from a received signal by using a preamble made up of an established, repeating training sequence added to the beginning of the packet, the packet detection apparatus comprising:
an autocorrelation calculator configured to solve for the autocorrelation of the received signal for each repeating period of the established training sequence;
a normalizer configured to normalize the autocorrelation computed by the autocorrelation calculator to the average received signal power in a given interval;
a plurality of serially-connected delay units each configured to apply delay equal to one repeating period of the established training sequence, wherein the number of delay units corresponds to the number of times the established training sequence is repeated;
a first summing unit configured to calculate the sum of the normalized autocorrelations respectively output from the normalizer and all of the serially-connected delay units;
a first determining unit configured to make a packet discovery determination on the basis of the result of comparing the first normalized autocorrelation sum output by the first summing unit to a first autocorrelation threshold value;
a second summing unit configured to calculate the sum of the normalized autocorrelations respectively output from the normalizer and a predetermined number of serially-connected delay units starting from the first; and
a second determining unit configured to make a packet discovery announcement determination on the basis of the result of comparing the second normalized autocorrelation sum output by the second summing unit to a second autocorrelation threshold value lower than the first autocorrelation threshold value.

6. The packet detection apparatus according to claim 5, wherein the total delay time calculated by the second summing unit and found in the output of the last delay unit is equivalent to the interval length for packet discovery announcement.

7. The packet detection apparatus according to claim 5, wherein the first determining unit additionally makes a packet discovery announcement if the second determining unit has not yet made a packet discovery announcement determination at the time of the first determining unit determining packet discovery.

8. A packet detection method whereby a packet is detected from a received signal by using a preamble made up of an established, repeating training sequence added to the beginning of the packet, the method comprising the steps of:
calculating a first autocorrelation of the received signal over a first interval;
making a packet discovery determination on the basis of the result of comparing the first autocorrelation computed in the first autocorrelation calculating step to a first autocorrelation threshold value;
calculating a second autocorrelation of the received signal over a second interval equivalent to the interval length for packet discovery announcement; and
making a packet discovery announcement determination on the basis of the result of comparing the second autocorrelation computed in the second autocorrelation calculating step to a second autocorrelation threshold value lower than the first autocorrelation threshold value.

9. A packet detection method whereby a packet is detected from a received signal by using a preamble made up of an established, repeating training sequence added to the beginning of the packet, the method comprising the steps of:
calculating the autocorrelation of the received signal for each repeating period of the established training sequence;
normalizing the autocorrelation computed in the autocorrelation calculating step to the average received signal power in a given interval;
calculating a first sum of the normalized autocorrelation obtained in the normalizing step and a number of delay signals wherein the normalized autocorrelation is successively delayed by one repeating period of the established training sequence, and wherein the number of delay signals is equal to the number of times the established training sequence is repeated;
making a packet discovery determination on the basis of the result of comparing the first normalized autocorrelation sum output in the first summing step to a first autocorrelation threshold value;
calculating a second sum of the normalized autocorrelation obtained in the normalizing step and a number of delay signals wherein the normalized autocorrelation is successively delayed by one repeating period of the established training sequence, up to a delay time equivalent to the interval length for packet discovery announcement; and
making a packet discovery announcement determination on the basis of the result of comparing the second normalized autocorrelation sum output in the second summing step to a second autocorrelation threshold value lower than the first autocorrelation threshold value.

10. A wireless communication apparatus, comprising:
a receiver configured to receive a packet wherein a preamble made up of an established, repeating training sequence has been added to the beginning thereof;
a first autocorrelation calculator configured to solve for a first autocorrelation of a received signal over a first interval;
a first determining unit configured to make a packet discovery determination on the basis of the result of comparing the first autocorrelation calculated by the first autocorrelation calculator to a first autocorrelation threshold value;
a second autocorrelation calculator configured to solve for a second autocorrelation of the received signal over a second interval equivalent to the interval length for packet discovery announcement;
a second determining unit configured to make a packet discovery announcement determination on the basis of the result of comparing the second autocorrelation computed by the second autocorrelation calculator to a second autocorrelation threshold value lower than the first autocorrelation threshold value; and
a packet discovery announcement processor configured to conduct predetermined processing in accordance with the packet discovery announcement determination made by the second determining unit.

11. A wireless communication apparatus, comprising:
a receiver configured to receive a packet wherein a preamble made up of an established, repeating training sequence has been added to the beginning thereof;
an autocorrelation calculator configured to solve for the autocorrelation of a received signal for each repeating period of the established training sequence;
a normalizer configured to normalize the autocorrelation computed by the autocorrelation calculator to the average received signal power in a given interval;
a plurality of serially-connected delay units each configured to apply delay equal to one repeating period of the established training sequence, wherein the number of delay units corresponds to the number of times the established training sequence is repeated;
a first summing unit configured to calculate the sum of the normalized autocorrelations respectively output from the normalizer and all of the serially-connected delay units;
a first determining unit configured to make a packet discovery determination on the basis of the result of comparing the first normalized autocorrelation sum output by the first summing unit to a first autocorrelation threshold value;
a second summing unit configured to calculate the sum of the normalized autocorrelations respectively output from the normalizer and a predetermined number of serially-connected delay units starting from the first;
a second determining unit configured to make a packet discovery announcement determination on the basis of the result of comparing the second normalized autocorrelation sum output by the second summing unit to a second autocorrelation threshold value lower than the first autocorrelation threshold value; and
a packet discovery announcement processor configured to conduct predetermined processing in accordance with the packet discovery announcement determination made by the second determining unit.

12. The wireless communication apparatus according to claim 10 or 11, wherein, in accordance with the packet discovery announcement, the packet discovery announcement processor outputs a CCA signal from the physical layer to the MAC layer or locks the AGC gain in the receiver.

13. A wireless communication method, comprising the steps of:
receiving a packet wherein a preamble made up of an established, repeating training sequence has been added to the beginning thereof;
calculating a first autocorrelation of the received signal over a first interval;
making a packet discovery determination on the basis of the result of comparing the first autocorrelation calculated in the first autocorrelation calculating step to a first autocorrelation threshold value;
calculating a second autocorrelation of the received signal over a second interval equivalent to the interval length for packet discovery announcement;
making a packet discovery announcement determination on the basis of the result of comparing the second autocorrelation computed in the second autocorrelation calculating step to a second autocorrelation threshold value lower than the first autocorrelation threshold value; and
conducting predetermined processing in accordance with the packet discovery announcement determination made in the packet discovery announcement determining step.

14. A wireless communication method, comprising the steps of:
receiving a packet wherein a preamble made up of an established, repeating training sequence has been added to the beginning thereof;
calculating the autocorrelation of the received signal for each repeating period of the established training sequence;
normalizing the autocorrelation computed in the autocorrelation calculating step to the average received signal power in a given interval;
calculating a first sum of the normalized autocorrelation obtained in the normalizing step and a number of delay signals wherein the normalized autocorrelation is successively delayed by one repeating period of the established training sequence, and wherein the number of delay signals is equal to the number of times the established training sequence is repeated;
making a packet discovery determination on the basis of the result of comparing the first normalized autocorrelation sum computed in the first summing step to a first autocorrelation threshold value;
calculating a second sum of the normalized autocorrelation obtained in the normalizing step and a number of delay signals wherein the normalized autocorrelation is successively delayed by one repeating period of the established training sequence, up to a delay time equivalent to the interval length for packet discovery announcement;
and making a packet discovery announcement determination on the basis of the result of comparing the second normalized autocorrelation sum computed in the second summing step to a second autocorrelation threshold value lower than the first autocorrelation threshold value.

15. A computer program stated in a computer-readable format so as to execute, on a computer, processing to detect a packet from a received signal by using a preamble made up of an established, repeating training sequence added to the beginning of the packet, the computer program causing the computer to execute the steps of:
calculating a first autocorrelation of the received signal over a first interval;
making a packet discovery determination on the basis of the result of comparing the first autocorrelation computed in the first autocorrelation calculating step to a first autocorrelation threshold value;
calculating a second autocorrelation of the received signal over a second interval equivalent to the interval length for packet discovery announcement; and
making a packet discovery announcement determination on the basis of the result of comparing the second autocorrelation computed in the second autocorrelation calculating step to a second autocorrelation threshold value lower than the first autocorrelation threshold value.

16. A computer program stated in a computer-readable format so as to execute, on a computer, processing to detect a packet from a received signal by using a preamble made up of an established, repeating training sequence added to the beginning of the packet, the computer program causing the computer to execute the steps of:
calculating the autocorrelation of the received signal for each repeating period of the established training sequence;
normalizing the autocorrelation computed in the autocorrelation calculating step to the average received signal power in a given interval;
calculating a first sum of the normalized autocorrelation obtained in the normalizing step and a number of delay signals wherein the normalized autocorrelation is successively delayed by one repeating period of the established training sequence, and wherein the number of delay signals is equal to the number of times the established training sequence is repeated;
making a packet discovery determination on the basis of the result of comparing the first normalized autocorrelation sum computed in the first summing step to a first autocorrelation threshold value;
calculating a second sum of the normalized autocorrelation obtained in the normalizing step and a number of delay signals wherein the normalized autocorrelation is successively delayed by one repeating period of the established training sequence, up to a delay time equivalent to the interval length for packet discovery announcement; and
making a packet discovery announcement determination on the basis of the result of comparing the second normalized autocorrelation sum computed in the second summing step to a second autocorrelation threshold value lower than the first autocorrelation threshold value.
